(19) United States
(12) Patent Application Publication
(10) Pub. No.: US 2010/0329879 A1
(43) Pub. Date: Dec. 30, 2010

(54) WIND TURBINE BLADES WITH MIXER LOBES

(76) Inventors: Walter M. Presz, JR., Wilbraham, MA (US); Michael J. Werle, West Hartford, CT (US); Thomas J. Kennedy, III, Wilbraham, MA (US); William Scott Keeley, Charlestown, RI (US)

Correspondence Address: O''Shea Getz P.C., 1500 MAIN ST. SUITE 912, SPRINGFIELD, MA, 01115, US

(21) Appl. No.: 12/793,361

(22) Filed: Jun. 3, 2010

Related U.S. Application Data
(60) Provisional application No. 61/183,643, filed on Jun. 3, 2009.

(51) Int. Cl. F03D 11/00; F03D 1/00

(52) U.S. Cl. 416/228; 416/235

(57) ABSTRACT

A horizontal axis wind turbine blade comprises a leading edge surface, a trailing edge surface, an upper camber surface extending between the leading edge surface and the trailing edge surface, and a lower camber surface extending between the leading edge surface and the trailing edge surface. Notably, the trailing edge surface includes a plurality of air flow mixing lobes. An ejector blade may be located above the upper camber surface and behind the trailing edge surface. The ejector blade may include an ejector blade trailing edge surface that includes a plurality of ejector blade mixing lobes. The ejector blade mixing lobes may include a plurality of ejector blade high energy mixing lobes and ejector blade low energy mixing lobes. Advantageously, the mixing lobes allow for a reduced wakes behind the HAWT and thus decrease the requisite separation distance between HAWTs in a wind farm.

### PRIORITY INFORMATION

This application claims benefit under 35 U.S.C. §119(e) to U.S. Provisional Patent Application Ser. No. 61/183,643 filed Jun. 3, 2009 and entitled “Mixer Lobes for HAWT Wind Turbine”, which is hereby incorporated by reference.

### BACKGROUND OF INVENTION

The present invention relates to the field of wind turbines, and in particular to horizontal wind turbines having turbine blades with mixing lobes.

Wind turbines typically have 2-5 blades arranged like a propeller, which are mounted to a horizontal shaft, which is attached to a gear box and a power generator. This type of wind turbine is often referred to as a horizontal axis wind turbine (HAWT). HAWT blades have an airfoil shape that captures wind energy.

Turbines used in wind farms for commercial production of electric power are usually three bladed and pointed into the wind by computer-controlled motors. The turbine typically includes a tubular steel towers from about 200 to 300 feet (60 to 90 meters) high. The blades rotate at 10-22 revolutions per minute in response to the wind. A gear box is commonly used to step up the speed of the generator, though there are also designs that use direct drive of an annular generator. Some models operate at constant speed, but more energy can be collected by variable-speed turbines which use a solid-state power converter to interface to the transmission system. HAWT turbines are equipped with high wind shut down features to avoid over speed damage. While HAWTs are being deployed in increasing numbers, the efficiency of the power extraction is not optimized.

HAWTs are subject to the Betz's theoretical limit where only about 59% of the wind's energy may be extracted from a hydraulic wind engine. Limitations in the theoretical efficiency arise from various factors including blockage of the HAWT machine and wind spilling off the blades. There is lower pressure behind the blades of a HAWT that is caused by the airfoil shape of the rotating blade passing through the air. The suction follows the blades and causes a large wake to form behind the HAWT. There is also a swirl of the air behind the HAWT that necessitates large spaces between the turbines in a wind farm.

Problems with HAWT include: difficulty operating in near ground, turbulent winds; the tall towers and blades up to 90 meters long are difficult/expensive to transport and install; massive tower construction is required to support the heavy blades, gearbox, and generator; tall HAWTs may affect airport radar; their height makes them obtrusively visible across large areas, disrupting the appearance of the landscape and sometimes creating local opposition; downwind variants suffer from fatigue and structural failure caused by turbulence; HAWTs require an additional yaw control mechanism to turn the blades toward the wind; ice build-up on the generator and the blades may cause power reduction and safety issues; and HAWT typically have a high angle of attack on their airfoils that do not lend themselves to changes in wind flow.

There is a need for improved for an improved HAWT design.

### SUMMARY OF THE INVENTION

According to an aspect of the invention, a wind turbine blade for a HAWT includes a leading edge and trailing edge, and a plurality of mixer lobes along the trailing edge.

A horizontal axis wind turbine blade comprises a leading edge surface, a trailing edge surface, an upper camber surface extending between the leading edge surface and the trailing edge surface, and a lower camber surface extending between the leading edge surface and the trailing edge surface. Notably, the trailing edge surface includes a plurality of air flow mixing lobes.

An ejector blade may be located above the upper camber surface and behind the trailing edge surface. The ejector blade may include an ejector blade trailing edge surface that includes a plurality of ejector blade mixing lobes. The ejector blade mixing lobes may include a plurality of ejector blade high mixing lobes and ejector blade low mixing lobes.

Advantageously, the mixing lobes allow for a reduced wakes behind the HAWT and thus decrease the requisite separation distance between HAWTs in a wind farm.

The blade may be made of a fiberglass composite with the resin content of the composite being 50% of less. The typical resins include unsaturated polyesters, vinyl esters and epoxy compounds.

The blades may be made in two halves using a resin infusion or layup process. The two halves are brought together and adhered to together, for example with methacrylate structural adhesives. The blades may be filament wound with resin coated fiberglass.

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1 is a perspective view of a horizontal axis wind turbine (HAWT) with blades having mixing lobes according to an aspect of the invention;

FIG. 2 is a perspective view of a turbine blade from the HAWT illustrated in FIG. 1;

FIG. 3 is a side view of the turbine blade illustrated in FIG. 2;

FIG. 4A is a perspective view of a second turbine blade embodiment;

FIG. 4B is a side view of the embodiment illustrated in FIG. 4A;

FIG. 5A is a perspective view of a third turbine blade embodiment;

FIG. 5B is a side view of the embodiment illustrated in FIG. 5A;

FIG. 6A is a perspective view of a fourth turbine blade embodiment;

FIG. 6B is a side view of the embodiment illustrated in FIG. 6A;

FIGS. 7A-7C graphically illustrate various lobe sizes;

FIG. 8A is a perspective view of a fifth turbine blade embodiment;

FIG. 8B is a cross section view of the embodiment illustrated in FIG. 8A;

FIG. 9A is a perspective view of a sixth turbine blade embodiment; and

FIG. 9B is a cross section view of the embodiment illustrated in FIG. 9A.

### DETAILED DESCRIPTION OF DRAWINGS

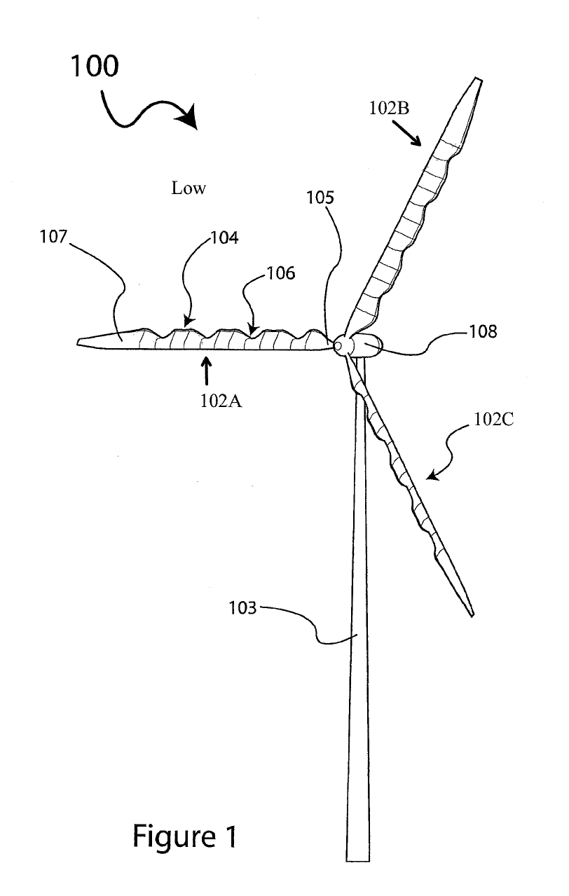

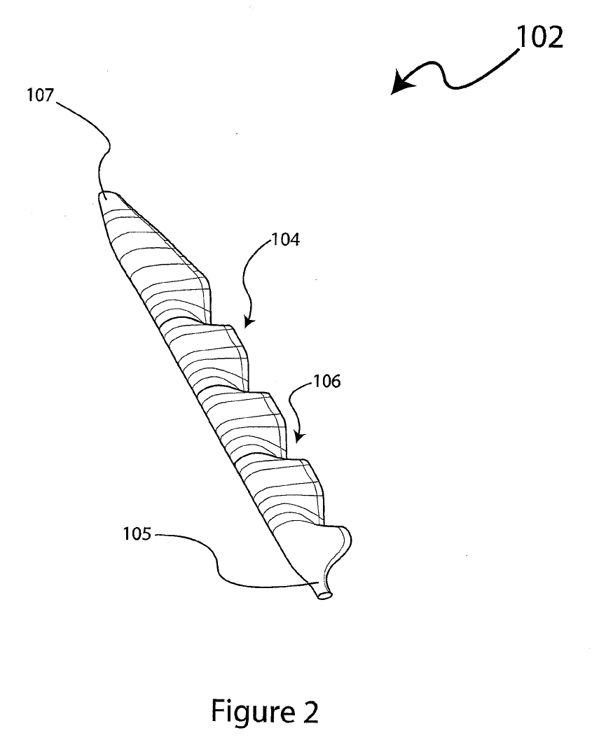

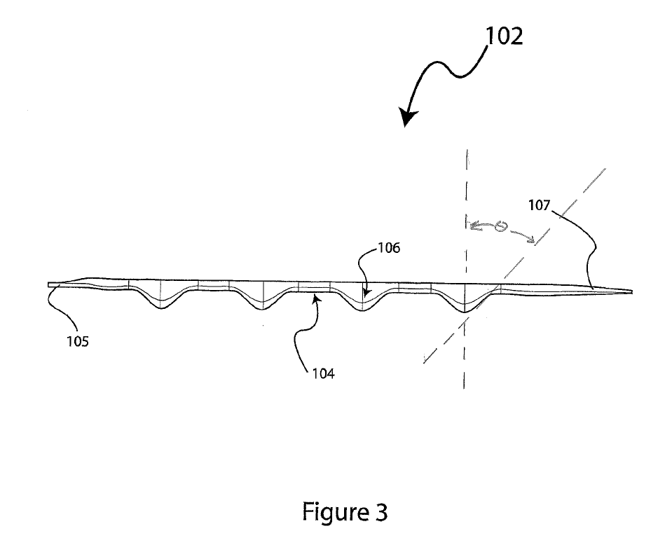

FIG. 1 illustrates a horizontal axis wind turbine (HAWT) 100. The wind turbine 100 includes a tower 103 that supports a nacelle 108 which contains electronic generation equipment (not shown). The turbine includes a plurality of blades 102a-102c (FIG. 2 and FIG. 3), which are each secured to the nacelle 108 at the proximal end 105 of the blade. Each of the blades 102a-102c comprises mixing lobes along a trailing edge of the blade, including low energy mixing lobes 104 and high energy mixing lobes 106. Each blade includes a distal end 107. It is contemplated that sidewalls of the lobes may taper at an angle ⊖ of about 5-65 degrees with respect to a chord line of the blade, as illustrated in FIG. 3.

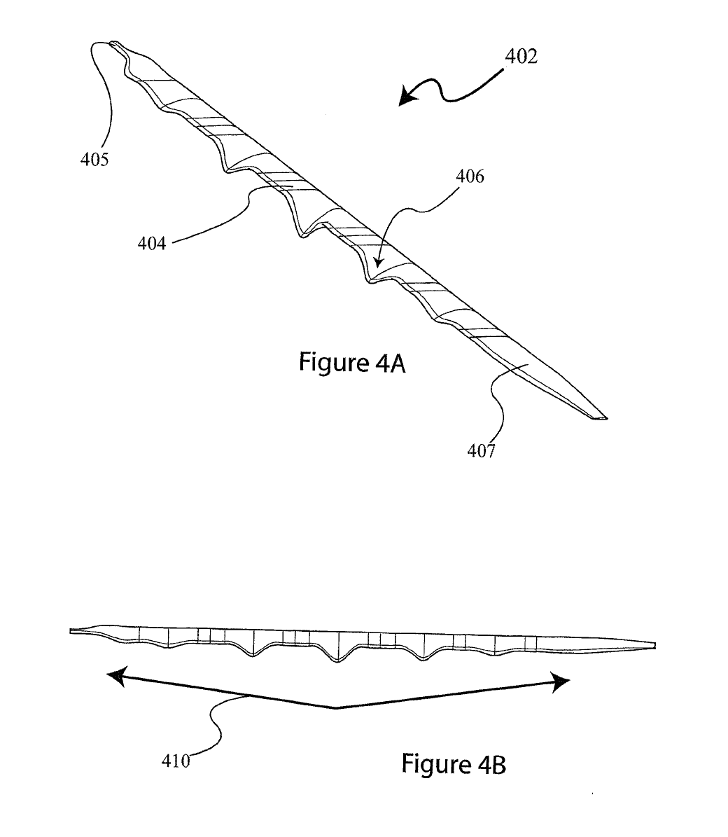

FIGS. 4A and 4B illustrate a second turbine blade 402, which includes varying sized high energy lobes 406 and low energy lobes 404. Arrows 410 (FIG. 4B) illustrate the relative change in size of the lobes 404, 406 from proximal end 405 to distal end 407 of the blade 402. In this embodiment, the size of the high energy lobes 406 decreases from the center of the blade outward to both the proximal and distal ends of the blade, as graphically shown by the arrow 410.

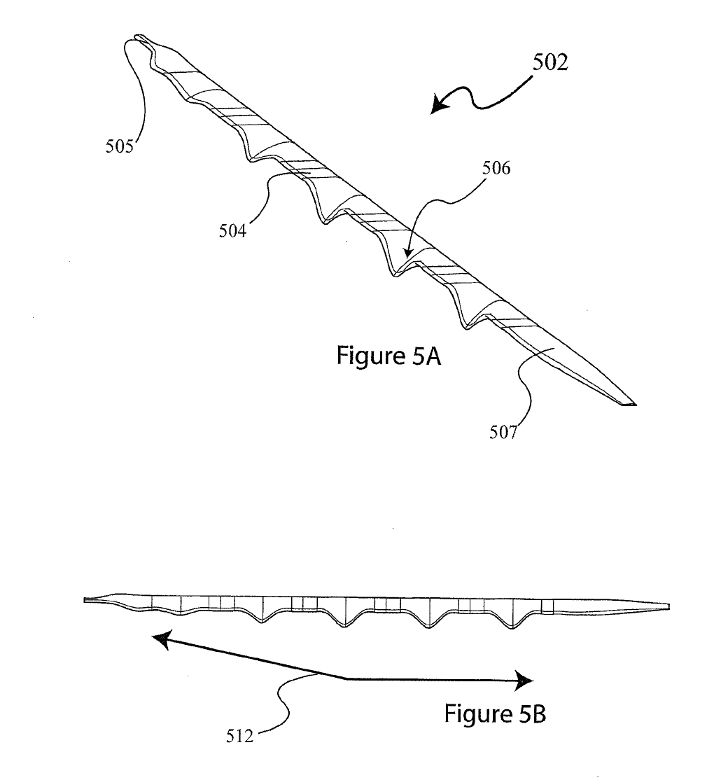

FIGS. 5A and 5B illustrate a third turbine blade 502, which includes mixing lobes 504, 506 that increase in size from proximal end 505 toward the center of the blade, and then maintains a similar size from the center of the blade to the distal end 607 as illustrated by arrows 512 in FIG. 5B.

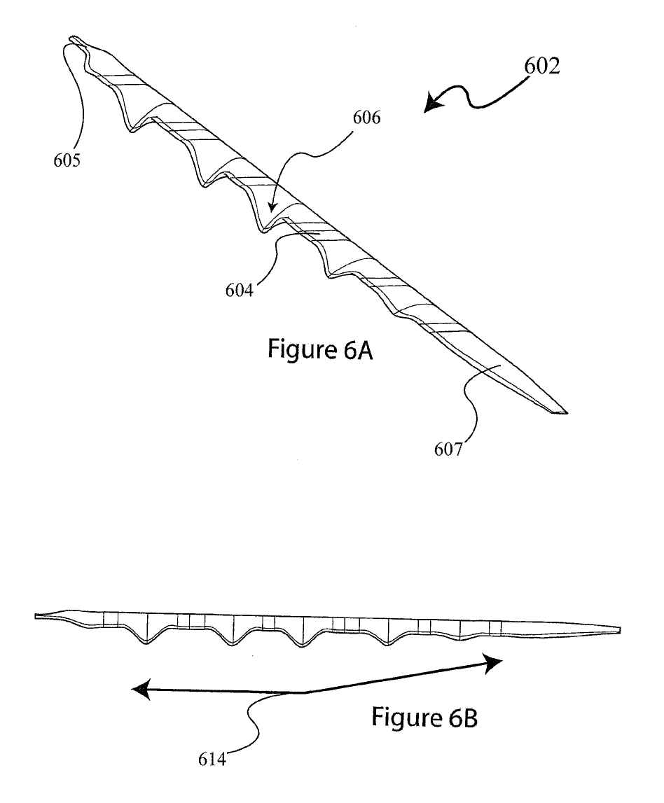

FIGS. 6A and 6B illustrate a fourth turbine blade 602, which includes mixing lobes 604, 606 the size which are similar from the proximal end 605 toward the center of the blade, and then decreased in size from the center of the blade toward the distal end 607 as illustrated by arrows 614 in FIG. 6B.

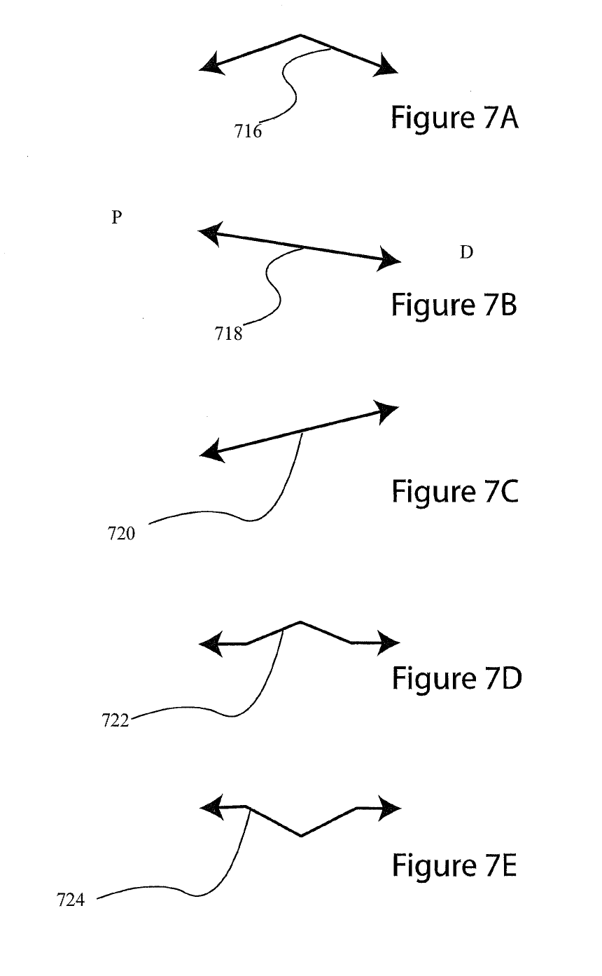

One of ordinary skill in the art will recognize that the size of the mixing lobes may change in various ways. For example as graphically shown in FIG. 7A, the size of the lobes may increase from the center of the blade towards the distal and proximate ends of the blade. Alternatively, as graphically shown in FIG. 7B, the size of the lobes may increase in size from the proximate end to the distal end. Conversely, as shown in FIG. 7C the size of the lobes may decrease from the proximate end to the distal end. FIG. 7D graphical illustrates an embodiment where the size of the lobes increase for a certain distance from the center of the blade towards the distal and proximate ends of the blade, and then remain constant from the certain distance from the center to the proximate and distal ends. FIG. 7E graphical illustrates an embodiment where the size of the lobes decrease for a certain distance from the center of the blade towards the distal and proximate ends of the blade, and then remain constant from the certain distance from the center to the proximate and distal ends. It is further contemplated that other mixing lobe configurations may be employed to enjoy the advantages of the present invention, including the reduction of wakes behind the HAWT. In addition, it is contemplated that the lobes may be uniformly or non-uniformly spaced longitudinally along the blade.

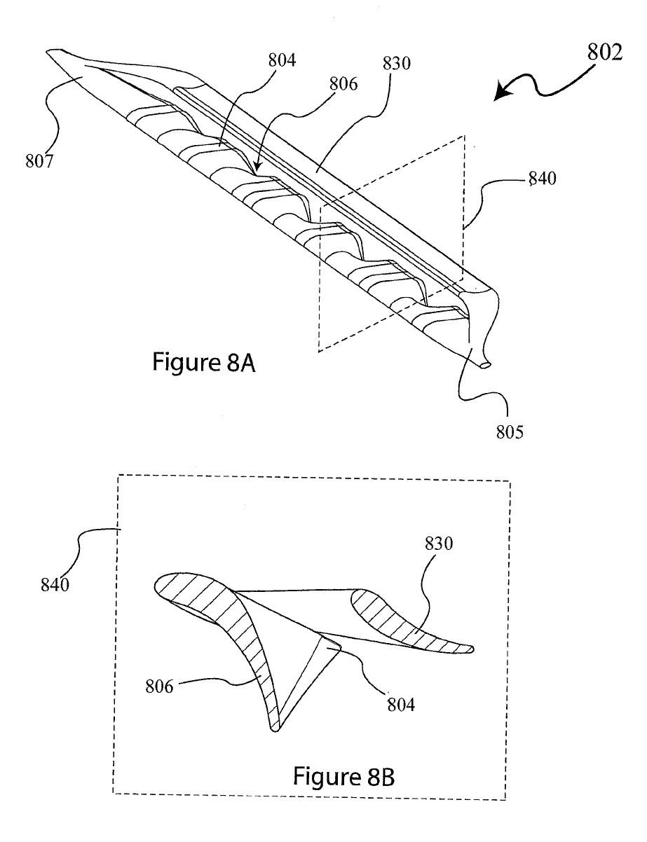

FIGS. 8A and 8B illustrate a perspective view and cross sectional view, respectively, of a fifth turbine blade embodiment 802. The area denoted by the rectangle 840 illustrates the cross section shown in FIG. 8B. The blade 802 includes a proximal end 805 that is engaged with a nacelle (not shown) in a similar manner to the aforementioned blade embodiments, and further comprises a distal end 807 with high energy lobes 806 and low energy lobes 804 located along the trailing edge of the blade between the proximal and distal ends. In addition, an ejector blade 830 is engaged with the proximal and distal ends of the blade 802 and located above and behind the trailing edge of the blade 802.

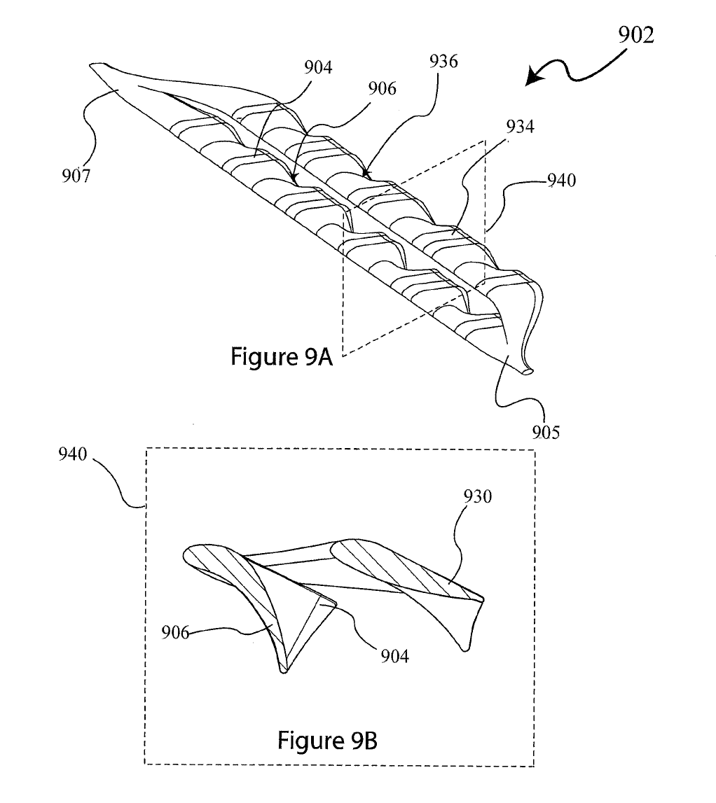

FIGS. 9A and 9B illustrate a perspective view and cross sectional view, respectively, of a sixth turbine blade embodiment 902. The area denoted by the rectangle 940 illustrates the cross section shown in FIG. 9B. The blade 902 includes a proximal end 905 that is engaged with a nacelle (not shown) in a similar manner to the aforementioned blade embodiments, and further comprises a distal end 907 with high energy lobes 906 and low energy lobes 904 located along the length of the trailing edge of the blade between the proximal and distal ends. In addition, a lobed ejector blade 930 located above and behind the trailing edge of the main blade may also include mixing lobes 936.

Although the present invention has been shown and described with respect to several preferred embodiments thereof, various changes, omissions and additions to the form and detail thereof, may be made therein, without departing from the spirit and scope of the invention.

What is claimed is:

1. A horizontal axis wind turbine blade, comprising:
a leading edge surface;
a trailing edge surface;
an upper camber surface extending between the leading edge surface and the trailing edge surface; and
a lower camber surface extending between the leading edge surface and the trailing edge surface;
where the trailing edge surface includes a plurality of air flow mixing lobes.

2. The blade of claim 1, where the plurality of air mixing lobes includes a plurality of high energy mixing lobes separated by a low energy mixing lobe.

3. The blade of claim 1, where the plurality of air mixing lobes includes a plurality of low mixing lobes separated by a high energy mixing lobe.

4. The blade of claim 1, further comprising an ejector blade that is located above the upper camber surface and behind the trailing edge surface.

5. The blade of claim 4, where the ejector blade comprises an ejector blade trailing edge surface that includes a plurality of ejector blade mixing lobes.

6. The blade of claim 5, where the ejector blade mixing lobes comprises a plurality of ejector blade high mixing lobes and ejector blade low mixing lobes.

7. A horizontal axis wind turbine, comprising:
a support tower having a base mountable to a surface, and a distal end;
a hub mounted to the distal end, which rotates a main shaft coupled to a gear box that provides a gear box shaft to rotate an electrical generator;
a plurality of blades rotabably secured to the hub, each blade comprising
a leading edge surface;
a trailing edge surface;
an upper camber surface extending between the leading edge surface and the trailing edge surface; and
a lower camber surface extending between the leading edge surface and the trailing edge surface;
where the trailing edge surface includes a plurality of air flow mixing lobes.

8. The horizontal axis wind turbine of claim 7, where the plurality of air mixing lobes includes a plurality of high energy mixing lobes separated by a low energy mixing lobe.

9. The horizontal axis wind turbine of claim 7, where the plurality of air mixing lobes includes a plurality of low mixing lobes separated by a high energy mixing lobe.

10. The horizontal axis wind turbine of claim 7, further comprising an ejector blade that is located above the upper camber surface and behind the trailing edge surface.

11. The horizontal axis wind turbine of claim 10, where the ejector blade comprises an ejector blade trailing edge surface that includes a plurality of ejector blade mixing lobes.

12. The horizontal axis wind turbine of claim 11, where the ejector blade mixing lobes comprises a plurality of ejector blade high mixing lobes and ejector blade low mixing lobes.
